(19) United States
(12) Patent Application Publication
(10) Pub. No.: US 2026/0115648 A1
(43) Pub. Date: Apr. 30, 2026

(54) Non-Triazine Based Scavengers

(71) Applicant: ChampionX LLC, Sugar Land, TX (US)

(72) Inventors: Boyd Anthony Laurent, Pearland, TX (US); Miranda Jocelynn Lozoya, Friendswood, TX (US); Matthew Aaron Trevino, Houston, TX (US); Maria Celeste Tria, Houston, TX (US)

(21) Appl. No.: 19/365,380

(22) Filed: Oct. 22, 2025

Related U.S. Application Data
(60) Provisional application No. 63/711,263, filed on Oct. 24, 2024.

(51) Int. Cl. B01D 53/14; B01D 19/00; B01D 53/52; B01D 53/78; C02F 1/20; C02F 101/10; C02F 103/10

(52) U.S. Cl. CPC B01D 53/1493; B01D 19/0005; B01D 53/1468; B01D 53/52; B01D 53/78; C02F 1/20; B01D 2252/2025; B01D 2252/60; B01D 2257/304; B01D 2258/05; C02F 2101/101; C02F 2103/10; C02F 2303/08

(57) ABSTRACT

A treatment composition includes a scavenger, an amine, and optionally a booster amine. A treatment composition may be contacted with an H₂S rich stream by direct addition of the composition to the H₂S rich stream, or by bubbling the H₂S rich stream through the composition. The H₂S rich stream may be e.g. a produced gas, a biogas, a crude oil, or a produced water. The treated streams have a reduced amount of H₂S (and/or another sulfhydryl compound) therein, when compared to the amount of H₂S in the stream prior to the treatment. The compositions and methods of treating are characterized by a substantial absence of, or reduction in the amount of precipitate formed thereby, when compared to methods and compositions of the prior art.

### TECHNICAL FIELD

The present disclosure generally relates to compositions, devices, and methods used in connection with hydrogen sulfide (H₂S) scavenging. More particularly, the disclosure provides compositions comprising non-triazine related scavengers.

### BACKGROUND

Sulfur compounds including hydrogen sulfide and mercaptans are often found in energy gas sources, including biogas sources collected from raw materials such as agricultural waste, manure, municipal waste, plant material, sewage, green waste, wastewater, and food waste and primarily composed of methane and carbon dioxide; and produced oil and gas sources collected from subterranean reservoirs.

Hydrogen sulfide, H₂S, can be found in many sources of produced oil and gas, including methane sources (“natural gas”), C1-C5 alkanes (“associated gas”); sources composed primarily of C3-C6 alkanes (“natural gas condensates”), and various liquid streams.

Hydrogen sulfide is well known to be an aggressive corrodent, in addition to being toxic to humans. The removal of hydrogen sulfide from liquid or gaseous hydrocarbon streams is also a problem that poses certain safety risks to both people and the processing facilities and production infrastructure that contact the corrodent. Because hydrogen sulfide is present in drilling, production, transportation, storage, and the processing of gas, crude oil, and waste water associated with crude oil, operators attempt to eliminate this from their products as early as possible in the production of oil and gas products to avoid issues downstream of a well head.

Various detrimental effects or impacts are known in the field related to non-containment and elimination of H₂S in oil and gas products. Corrosion of the completion string of a producing wellbore, caused by contact with the continuously flowing stream of sulfur compound-bearing produced fluids, is a continuous challenge in the collection and processing of energy liquid sources. Corrosion of interior surfaces of metal conduits and pipelines can occur at all points within the produced fluid transportation if H₂S is not eliminated. Thus, removal of sulfur compounds such as hydrogen sulfide from crude oils and produced water is a critical step in the production and refining of these energy liquid sources.

Removal of all or substantially all gas-phase sulfur compounds, including but not limited to H₂S, is required in the processing of liquefied energy gas products, such as liquefied natural gas. The presence of reactive sulfhydryl compounds such as H₂S may result in the formation and subsequent deposition of sulfur containing reaction products, which can cause plugging and corrosion of transmission pipes, valves, regulators, and other equipment.

Industrially, H₂S scavengers are used to remove H₂S and other sulfydryl species from produced fluids (oil, water, gas) from a reservoir. By reacting with H₂S to form a spent scavenger or other chemical by-product of the scavenging reaction, certain H₂S scavengers can manifest as a solid reaction by-product. This solid reaction by-product may cause fluid processing challenges as the solids can plug or restrict oilfield production equipment such as gas processing towers or flowlines. It is desired for the spent scavenger by-product remain in a liquid flowable form throughout the processing of oil and gas.

This invention has identified additives that improve the scavenging efficacy (reaction catalyst) of certain scavenger solutions and also exhibits reduction in the formation of solid scavenger by-products.

### BRIEF SUMMARY

H₂S scavengers of the hemiformal type can manifest solids after the reaction with H₂S. Previous inventions disclosed have identified certain formulation combinations to increase the kinetics or amount of H₂S scavenged by the hemiformal type H₂S scavengers (U.S. Pat. No. 10,538,710 B2; U.S. Pat. No. 11,802,246 B2) as well as identified certain additives designed to slow the formation of problematic solids in the spent scavenger product (U.S. Pat. No. 10,336,950 B2; U.S. Pat. No. 11,499,108 B2; U.S. Pat. No. 11,530,347 B2).

We have identified several new compositions for scavenging H₂S and/or other sulfydryl compounds that are different from those described previously, that provides excellent scavenging kinetics while also slowing or preventing the formation of problematic solids that tend to form using scavengers of this type.

The compositions utilize hemiacetal type scavengers, which are the reaction product of an alkanol or a polyol with an aldehyde, co-formulated with at least one amine to increase kinetics of the scavenging reaction. In the case of hemiformals (hemiacetals based on formaldehyde), performance without the incorporation of amine compounds results in slow kinetic reaction with H₂S, resulting in poor performance of the scavenging composition. Addition of triethanolamine of the previous art can improve the kinetics of the hemiformal scavenging reaction; however, the spent scavenger by-product solution manifests as undesirable solids after several days of aging, eventually as a completely solid mass. The invention identified herein, identifies certain amines and amine mixtures that provide a rapid scavenging reaction while the reaction products obtain a flowable spent scavenger by-product, and/or exhibit significantly less solids formation when compared to hemiformal type H₂S scavengers of the prior art.

Examples of hemiformal type inhibitors include those formed by the reaction of an alkanol (or polyol) with formaldehyde (or formaldehyde equivalent) and include but are not limited to alkoxymethanols including methoxymethanol and ethoxymethanol; reaction products of ethylene glycol with formaldehyde; or reaction products of glycerol with formaldehyde (“formolglycerin” or “glycerol formal”, CAS #68442-91-1). Other hemiacetal type scavengers can be used that are based on methanol, ethanol, propanol, butanol, propylene glycol or other alkanols or polyols.

The amine is a primary, secondary, or tertiary amine having one or more substituted or unsubstituted linear, branched, or cyclic alkyl, aryl, or alkaryl moieties. Examples of amines usefully employed herein include, but are not limited to acyclic secondary amines, and monocyclic, bicyclic, or polycyclic amines having one or more amine moiety. Particularly useful cyclic amines include at least one secondary amine moiety. In embodiments, the amine excludes primary amine moieties.

Certain amines show a greater than additive scavenging effect when present in a blend thereof, further mixed with a hemiacetal type scavenger. Accordingly, in some optional embodiments herein, the compositions utilize a booster amine in addition to the scavenger and the amine. The amine and the booster amine are selected from the same group of compounds, but are chemically distinct. The amine/booster amine combination provides an advantageous balance of high rate of H2S scavenging performance, and solids suppression. Solids suppression refers to avoiding precipitation of the reaction products of the scavenging reaction, or avoiding fouling of surfaces by precipitated solids.

The compositions of the invention may be utilized neat or diluted in a variety of solvents such as water, alkanols, alkoxyalkanols, aliphatic hydrocarbons, aromatic hydrocarbons, or any mixture thereof.

Also disclosed herein are glyoxal treatment compositions comprising, consisting essentially of, or consisting of a mixture of a hemiacetal, a tertiary amine, and glyoxal. In embodiments, the weight ratio of glyoxal to the hemiacetal in the glyoxal treatment compositions is between 1:2 and 1:10. In embodiments, the glyoxal treatment composition includes about 20 parts to about 80 parts by weight of a hemiacetal, about 1 part to 20 parts by weight of the tertiary amine, and about 10 to 40 parts by weight of glyoxal. In embodiments, the glyoxal treatment compositions further include a solvent, such as between 20% and 80% of the solvent by weight or weight/volume (w/v). The glyoxal treatment compositions are useful for scavenging H2S from H2S rich streams while also suppressing solids.

### DETAILED DESCRIPTION

Although the present disclosure provides references to preferred embodiments, persons skilled in the art will recognize that changes may be made in form and detail without departing from the spirit and scope of the invention. Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

As used herein, the term “solvent” means any single compound or mixture of two or more compounds, wherein the compound or mixture thereof is substantially liquid within at least a portion of the range between 0° C. and 100° C. at 1 atm.

As used herein, the term “H₂S rich” as applied to a fluid stream means that the fluid stream includes a measurable amount of H₂S and/or another sulfhydryl compound, where sulfhydryl compounds include any compound having an —SH group.

As used herein, the term “precipitate” and like terms refer to a solid material that is present within a fluid, but is not dissolved therein.

As used herein, the term “foulant” refers to a precipitate that is substantially statically situated in association with the interface between a liquid phase and a solid surface, such as a separator or the wall of a conduit or containment. Accordingly, the term “fouling” refers herein to the process of a precipitate becoming statically associated with the interface between a liquid and a conduit or containment wall.

As used herein, the terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising,” “consisting of” and “consisting essentially of,” the embodiments or elements presented herein, whether explicitly set forth or not.

As used herein, the term “optional” or “optionally” means that the subsequently described event or circumstance may but need not occur, and that the description includes instances where the event or circumstance occurs and instances in which it does not.

As used herein, the term “about” modifying, for example, the quantity of an ingredient in a composition, concentration, volume, process temperature, process time, yield, flow rate, pressure, and like values, and ranges thereof, employed in describing the embodiments of the disclosure, refers to variation in the numerical quantity that can occur, for example, through typical measuring and handling procedures used for making compounds, compositions, concentrates or use formulations; through inadvertent error in these procedures; through differences in the manufacture, source, or purity of starting materials or ingredients used to carry out the methods, and like proximate considerations. The term “about” also encompasses amounts that differ due to aging of a formulation with a particular initial concentration or mixture, and amounts that differ due to mixing or processing a formulation with a particular initial concentration or mixture. Where modified by the term “about” the claims appended hereto include equivalents to these quantities. Further, where “about” is employed to describe a range of values, for example “about 1 to 5” the recitation means “1 to 5”, “about 1 to about 5”, “1 to about 5” and “about 1 to 5” unless specifically limited by context.

As used herein, the word “substantially” modifying, for example, the type or quantity of an ingredient in a composition, a property, a measurable quantity, a method, a position, a value, or a range, employed in describing the embodiments of the disclosure, refers to a variation that does not affect the overall recited composition, property, quantity, method, position, value, or range thereof in a manner that negates an intended composition, property, quantity, method, position, value, or range. Examples of intended properties include, solely by way of non-limiting examples thereof, flexibility, partition coefficient, rate, solubility, temperature, and the like; intended values include thickness, yield, weight, concentration, and the like. The effect on methods that are modified by “substantially” include the effects caused by variations in type or amount of materials used in a process, variability in machine settings, the effects of ambient conditions on a process, and the like wherein the manner or degree of the effect does not negate one or more intended properties or results; and like proximate considerations. Where modified by the term “substantially” the claims appended hereto include equivalents to these types and amounts of materials.

### First Embodiments

Disclosed in first embodiments herein are compositions for removing H₂S from an H₂S rich stream. In any one or more first embodiments herein, the compositions are also effective for removing one or more sulfhydryl compounds other than H₂S that are present in the H₂S rich stream. In any one or more first embodiments herein, the compositions of first embodiments comprise, consist essentially of, or consist of a mixture of a scavenger and an amine, and optionally a booster amine. In some first embodiments, the compositions further comprise a solvent and/or one or more adjuvants. In such embodiments, the scavenger, amine, and optional booster amine present in the compositions are referred to herein as “actives”.

Scavengers. In any one or more compositions of first embodiments herein, the scavenger comprises, consists essentially of, or consists of one or more hemiacetals. A hemiacetal is a reaction product of an aldehyde source with an alkanol, or with a polyol. Such hemiacetal reaction products are disclosed, for example, in U.S. Pat. No. 10,538,710 B2.

In any one or more compositions of first embodiments herein, the hemiacetal comprises, consists essentially of, or consists of a hemiformal, wherein the aldehyde source is a formaldehyde source. In some such embodiments, the formaldehyde source is formaldehyde or formalin.

In any one or more first embodiments herein, the hemiformal is the reaction product of a formaldehyde source with an alkanol. In some such embodiments, the hemiformal is the reaction product of one mole of the formaldehyde source with one mole of the alkanol. In some such embodiments, the alkanol is a C1-C8 alkanol or a combination of two or more C1-C8 alkanols. In some such embodiments, the alkanol comprises, consists essentially of, or consists of methanol, ethanol, propanol or a structural isomer or cyclic analog thereof, butanol or a structural isomer or cyclic analog thereof, pentanol or a structural isomer or cyclic analog thereof, hexanol or a structural isomer or cyclic analog thereof, heptanol or a structural isomer or cyclic analog thereof, octanol or a structural isomer or cyclic analog thereof, or any combination thereof. Accordingly, for example, “hexanol” means a C6 alkanol selected from n-hexanol, 2-hexanol, 3-hexanol, cyclohexanol, 2-methylpentanol, 2-methylcyclopentanol, 2,3-dimethylbutanol, and any other structural isomer or cyclic analog thereof, unless a particular isomer or analog is specified.

In any one or more other first embodiments herein, the hemiformal is the reaction product of a formaldehyde source with one or more polyols. A polyol is an alkanol having two or more hydroxyl moieties. In some such embodiments, the hemiformal is the reaction product of one or one mole of the formaldehyde source with one mole of hydroxyl functionality present on the polyol. In embodiments, the polyol is ethylene glycol, diethylene glycol, triethylene glycol, 1,2-propylene glycol, 1,3-propylene glycol, glycerol, trimethylolpropane, erythritol, pentaerythritol, a C5-C6 sugar, a C5-C6 sugar alcohol, or any combination thereof. Where a polyol includes two hydroxyl moieties, the corresponding hemiformal is the reaction product of one or two moles of a formaldehyde source with one mole of the polyol. Where the polyol includes three hydroxyl moieties, the hemiformal is the reaction product of one, two, or even three moles of a formaldehyde source with one mole of the polyol. Where the polyol includes four hydroxyl moieties, the hemiformal is the reaction product of one, two, three, or even four moles of a formaldehyde source with one mole of the polyol. Where the polyol includes five hydroxyl moieties, the hemiformal is the reaction product of one, two, three, four, or even five moles of a formaldehyde source with one mole of the polyol. Where the polyol includes six hydroxyl moieties, the hemiformal is the reaction product of one, two, three, four, five, or even six moles of a formaldehyde source with one mole of the polyol.

In any one or more first embodiments herein, the hemiacetal is the reaction product of one to six moles of an aldehyde source with any one or more of the foregoing alkanols or polyols. In some such embodiments, the aldehyde source is selected from any one or more acetaldehyde sources, benzaldehyde sources, glyoxal sources, or glutaraldehyde sources.

In any one or more first embodiments herein, the scavenger comprises, consists essentially of, or consists of an alkoxylated alkanol or an alkoxylated polyol, that is, an organic compound having both alkoxy and hydroxyl functionality. In any one or more first embodiment herein, the alkoxylated alkanol is an alkoxylated methanol such as methoxymethanol or ethoxymethanol; an alkoxylated dimethanol such as (ethylenedioxy)dimethanol (“EDDM”, CAS #3586-55-8); or glycerol formal (also known as formolglycerin”, CAS #68442-91-1).

Amines. In any one or more first embodiments herein, the amine comprises, consists essentially of, or consists of one or more organic amine compounds. In embodiments, the organic amine compound comprises, consists essentially of, or consists of a linear, branched, or cyclic amine. In embodiments, the organic amine compound comprises, consists essentially of, or consists of one or more primary, secondary, or tertiary amines or a combination of two or more of these. In some embodiments, the amine is acyclic. In other embodiments, the amine is cyclic. In embodiments, the amine comprises one amine moiety; in other embodiments the amine comprises two amine moieties, three amine moieties, or even four amine moieties or more.

In any one or more first embodiments herein, the amine comprises one amine moiety; in such embodiments, the one amine moiety is a primary amine, a secondary amine, or a tertiary amine. In some such embodiments, the amine is a secondary amine. In some embodiments the secondary amine is a dialkylamine, further wherein the two alkyl moieties of the dialkylamine are independently C1-C6 alkyl moieties; that is, the two alkyl moieties of the dialkylamine are the same or different. In some embodiments the two alkyl moieties of the dialkylamine are the same (identical). In any one or more first embodiments herein, one or both alkyl moieties of the secondary amine (dialkylamine) comprise, consist essentially of, or consist of methyl, ethyl, any structural isomer or cyclic analog of propyl, any structural isomer or cyclic analog of butyl; any structural isomer or cyclic analog of pentyl, any structural isomer or cyclic analog of hexyl, any structural isomer or cyclic analog of heptyl; any structural isomer or cyclic analog of octyl. Accordingly, in some first embodiments, the composition includes an amine selected from dimethylamine, diethylamine, di-n-propylamine, di-iso-propylamine, di-n-butylamine, di-iso-butylamine, di-t-butylamine, di-n-pentylamine, di-is-pentylamine, di-neo-pentane, di-n-hexylamine, di-(2-methylpentyl)amine, di-(3-methylpentyl)amine, di-(2,2-dimethylbutyl)amine, or di-(2,3-dimethylbutyl)amine, or any combination thereof.

In any one or more amines of first embodiments herein, the amine is an alkanolamine selected from monoalkanolamines, dialkanolamines, alkylalkanolamines, trialkanolamines, or any combination thereof, further wherein the one or more alkanol moieties of the alkanolamine are independently C1-C6 alkanol moieties and the alkyl moiety of the alkylalkanolamine is a C1-C6 alkyl moiety. In any one more first embodiments herein, the amine is selected from ethanolamine (a primary amine), diethanolamine (a secondary amine), triethanolamine (a tertiary amine); or any combination of these. In any one or more first embodiments herein, the amine comprises, consists essentially of, or consists of an alkylalkanolamine, which is a secondary amine having one C1-C6 alkyl moiety and one C1-C6 alkanol moiety. Suitable but nonlimiting examples of alkylalkanolamines include methylpropanolamine and butylethanolamine. In any one or more first embodiments herein, the amine comprises, consists essentially of, or consists of a combination of one or more alkylalkanolamines with one or more dialkylamines, or a combination of one or more alkylalkanolamines with one or more dialkanolamines, or a combination of one or more dialkylamines and one or more dialkanolamines. In any one or more first embodiments herein, the amine comprises, consists essentially of, or consists of a combination of one or more alkylalkanolamines with one or more dialkylamines, one or more dialkanolamines, or both of these.

In any one or more first embodiments herein, the amine is a cyclic amine selected from monocyclic, bicyclic, or polycyclic amines having one or more amine moieties. In any one or more first embodiments herein, the cyclic amine includes 1, 2, 3, 4, or 5 amine moieties. In any one or more first embodiments herein, the cyclic amine includes 4-40 carbons, such as 4-12 carbons, 12-20 carbons, 20-30 carbons, or even 30-40 carbons. In any one or more first embodiments herein, the cyclic amine includes at least one secondary amine moiety. In any one or more first embodiments herein, the cyclic amine excludes primary amine moieties. In any one or more first embodiments herein, the cyclic amine excludes tertiary amine moieties. In any one or more first embodiments herein, the cyclic amine excludes both primary and tertiary amine moieties. In some embodiments, the cyclic amine excludes amine moieties that are not joined within a ring.

Cyclic amines usefully employed herein include, but are not limited to monoamines and diamines such as aziridine and derivatives thereof, azetidine and derivatives thereof, pyrrolidine and derivatives thereof, piperidine and derivatives thereof, morpholine and derivatives thereof, azepane and derivatives thereof, indole and derivatives thereof, piperazine and derivatives thereof, azocane and derivatives thereof, diaminocyclohexane and derivatives thereof, homopiperazine and derivatives thereof, imidazoline and derivatives thereof, pyrrolidine-2,5-diamine and derivatives thereof, amino-functional polycyclic alkaloids such as nicotine, 1,4-diazabicyclo[2.2.2]octane (DABCO), 1-azaadamantane and derivatives thereof, 1,3-diazaadamantane and derivatives thereof, acosamine, quinuclidine and derivatives thereof, or any combination of these.

Booster amine. As noted above, the compositions of first embodiments optionally include a booster amine in addition to a scavenger and an amine. In embodiments, the booster amine is an amine that is selected from any of the amines listed above, but is different chemically therefrom. Additionally, the booster amine is present in the compositions of first embodiments herein in an amount that is less than 50% of the total weight of the amine and booster amine combined. In any one or more first embodiments herein, the booster amine comprises, consists essentially of, or consists of a secondary amine. In any one or more first embodiments herein, the amine comprises, consists essentially of, or consists of an acyclic amine and the booster amine comprises, consists essentially of, or consists of a cyclic amine. In any one or more first embodiments herein, the composition includes two or more booster amines. In any one or more first embodiments herein, the amine and the booster amine are both cyclic amines. In any one or more first embodiments herein, the amine and the booster amine both include at least one secondary amine moiety.

In any one or more first embodiments herein, proportion of the amine to the booster amine in the composition is about 2:1 to about 100:1 by weight, for example 2:1 to 100:1, or 2:1 to 99:1, or 2:1 to 98:1, or 2:1 to 95:1, or 2:1 to 90:1, or 2:1 to 80:1, or 2:1 to 70:1, or 2:1 to 60:1, or 2:1 to 50:1, or 2:1 to 40:1, or 2:1 to 30:1, or 2:1 to 20:1, or 2:1 to 10:1, or 2:1 to 8:1, or 2:1 to 6:1, or 2:1 to 4:1, or 4:1 to 100:1, or 6:1 to 100:1, or 8:1 to 100:1, or 10:1 to 100:1, or 20:1 to 100:1, or 30:1 to 100:1, or 40:1 to 100:1, or 50:1 to 100:1, or 60:1 to 100:1, or 70:1 to 100:1, or 80:1 to 100:1, or 90:1 to 100:1, or 2:1 to 10:1, or 10:1 to 20:1, or 20:1 to 30:1, or 30:1 to 40:1, or 40:1 to 50:1, or 50:1 to 60:1, or 60:1 to 70:1, or 70:1 to 80:1, or 80:1 to 90:1, or about 90:1, or about 80:1, or about 70:1, or about 60:1, or about 50:1, or about 40:1, or about 30:1, or about 20:1, or about 10:1, or about 9:1, or about 8:1, or about 7:1, or about 6:1, or about 5:1, or about 4:1, or about 3:1, or about 2:1 by weight.

In any one or more first embodiments herein, the weight proportion of the scavenger to the total weight of the amine and the booster amine in the composition is about 100:1 to about 1:1, for example 1:1 to 90:1, or 1:1 to 80:1, or 1:1 to 70:1, or 1:1 to 60:1, or 1:1 to 50:1, or 1:1 to 40:1, or 1:1 to 30:1, or 1:1 to 20:1, or 1:1 to 10:1, or 1:1 to 8:1, or 1:1 to 6:1, or 1:1 to 4:1, or 4:1 to 100:1, or 6:1 to 100:1, or 8:1 to 100:1, or 10:1 to 100:1, or 20:1 to 100:1, or 30:1 to 100:1, or 40:1 to 100:1, or 50:1 to 100:1, or 60:1 to 100:1, or 70:1 to 100:1, or 80:1 to 100:1, or 90:1 to 100:1, or 1:1 to 10:1, or 10:1 to 20:1, or 20:1 to 30:1, or 30:1 to 40:1, or 40:1 to 50:1, or 50:1 to 60:1, or 60:1 to 70:1, or 70:1 to 80:1, or 80:1 to 90:1, or about 90:1, or about 80:1, or about 70:1, or about 60:1, or about 50:1, or about 40:1, or about 30:1, or about 20:1, or about 10:1, or about 9:1, or about 8:1, or about 7:1, or about 6:1, or about 5:1, or about 4:1, or about 3:1, or about 2:1, or about 1:1 by weight of the scavenger to the total weight of the amine and the booster amine.

Compositions generally. In any one or more first embodiments herein, the composition consists essentially of or consists of the scavenger, the amine, and optionally one or more booster amines. In some such embodiments, the composition is “neat”, that is, the composition excludes a solvent. In some such embodiments, the composition consists essentially of or consists of about 20 to about 80 parts by weight of the scavenger, such as 20-30 parts, 30-40 parts, 40-50 parts, 50-60 parts, 60-70 parts, or 70-80 parts by weight of the scavenger, and about 1 part to about 20 parts by weight of a combination of the amine and the booster amine, such as 1-2 parts, 2-4 parts, 4-6 parts, 6-8 parts, 8-10 parts, 10-12 parts, 12-14 parts, 14-16 parts, 16-18 parts, or 18-20 parts of the amine/booster amine combination.

In any one or more first embodiments herein, the composition includes the scavenger, the amine, and optionally one or more booster amines; and further includes a solvent, where the solvent is any single compound or mixture of two or more compounds that is substantially liquid within at least a portion of the range between 0° C. and 100° C. at 1 atm. In some such embodiments, the composition comprises, consists essentially of, or consists of the actives and the solvent. In some such embodiments the solvent comprises, consists essentially of, or consists of water, one or more alkanols, one or more aliphatic hydrocarbons, one or more aromatic hydrocarbons, one or more alkoxyalkanols, one or more petroleum-based liquid mixture, or any combination thereof. In some first embodiments, the solvent excludes water. In some first embodiments, the solvent consists of or consists essentially of water.

In any one or more first embodiments herein, the one or more alkanols employed as a solvent in the composition comprise, consist essentially of, or consist of methanol, ethanol, propanol or a structural isomer or cyclic analog thereof, butanol or a structural isomer or cyclic analog thereof, pentanol or a structural isomer or cyclic analog thereof, hexanol or a structural isomer or cyclic analog thereof, heptanol or a structural isomer or cyclic analog thereof, octanol or a structural isomer or cyclic analog thereof, or any combination thereof. In some embodiments, the alkanol is methanol, n-butanol, iso-propanol, or any combination thereof.

In any one or more first embodiments herein, the one or more aliphatic hydrocarbons employed as a solvent in the composition comprise, consist essentially of, or consist of C5-C16 linear, cyclic, or branched alkanes or alkenes, including n-pentane or a structural isomer or cyclic analog thereof, n-hexane or a structural isomer or cyclic analog thereof, 1-pentene or a structural isomer or cyclic analog thereof, n-hexane or a structural isomer or cyclic analog thereof, 1-hexene or a structural isomer or cyclic analog thereof, n-heptane or a structural isomer or cyclic analog thereof, 1-heptene or a structural isomer or cyclic analog thereof, n-octane or a structural isomer or cyclic analog thereof, 1-octene or a structural isomer or cyclic analog thereof, n-nonane or a structural isomer or cyclic analog thereof, 1-nonene or a structural isomer or cyclic analog thereof, n-decane or a structural isomer or cyclic analog thereof, 1-decene or a structural isomer or cyclic analog thereof, n-undecane or a structural isomer or cyclic analog thereof, 1-undecene or a structural isomer or cyclic analog thereof, n-dodecane or a structural isomer or cyclic analog thereof, 1-dodecene or a structural isomer or cyclic analog thereof, n-tridecane or a structural isomer or cyclic analog thereof, 1-tridecene or a structural isomer or cyclic analog thereof, n-tetradecane or a structural isomer or cyclic analog thereof, 1-tetradecene or a structural isomer or cyclic analog thereof, n-pentadecane or a structural isomer or cyclic analog thereof, n-pentadecene or a structural isomer or cyclic analog thereof, n-hexadecane or a structural isomer or cyclic analog thereof, or 1-hexadecene or a structural isomer or cyclic analog thereof.

In any one or more first embodiments herein, the one or more aromatic hydrocarbons employed as a solvent in the composition comprise, consist essentially of, or consist of benzene, toluene, xylene, a naphtha solvent including aromatic content, for example heavy aromatic naphtha (HAN); or any combination thereof.

In any one or more first embodiments herein, the one or more alkoxyalkanols employed as a solvent in the composition have a structure corresponding to R¹OR²OH, wherein R¹ and R² are independently selected from C1-C6 hydrocarbyl moieties. In some embodiments, R² is —CH₂—. In some embodiments, R¹ is —CH₃, —CH₂—CH₃, —CH₂—CH₂—CH₃, or —CH₂—CH₂—CH₂—CH₃. In any one or more first embodiments herein, the one or more alkoxyalkanols comprise, consist essentially of, or consist of 2-butoxyethanol (ethylene glycol monobutyl ether, “EGMBE”). In any one or more first embodiments herein, the solvent comprises EGMBE and at least one alkanol, and/or at least one aliphatic hydrocarbon, and/or at least one aromatic hydrocarbon.

In some first embodiments herein, a hemiacetal is employed as a solvent in the composition. In embodiments where a hemiacetal is a liquid within at least a portion of the range between 0° C. and 100° C. at 1 atm, it can function as a reactive solvent in the compositions of first embodiments—that is, a solvent that is also a scavenger. Accordingly, since the weight proportion of the scavenger to the total weight of the amine and the booster amine in any one or more compositions of first embodiments herein is about 100:1 to about 1:1, an amount of hemiacetal or a species of hemiacetal present in the composition may function as a solvent.

In any one or more first embodiments herein, the one or more petroleum-based liquid mixtures employed as a solvent in the composition are refined petroleum mixtures selected from diesel fuels, gasolines, jet fuels, kerosene, petroleum middle distillates, or any combination thereof.

Any of the foregoing solvent compounds may be suitably mixed in any ratio to obtain a solvent that is useful as the non-active component of the compositions of first embodiments herein. In embodiments, the actives—that is, the scavenger, the amine, and the optional booster amine—are present at about 0.1% to about 99% by weight of the composition, for example 0.1% to 99%, or 0.1% to 98%, or 0.1% to 95%, or 0.1% to 90%, or 0.1% to 80%, or 0.1% to 70%, or 0.1% to 60%, or 0.1% to 50%, or 0.1% to 40%, or 0.1% to 30%, or 0.1% to 20%, or 0.1% to 10%, or 0.1% to 5%, or 0.1% to 4%, or 0.1% to 3%, or 0.1% to 2%, or 0.1% to 1%, or 1% to 5%, or 5% to 10%, or 10% to 15%, or 15% to 20%, or 20% to 25%, or 25% to 30%, or 30% to 40%, or 40% to 50%, or 50% to 60%, or 60% to 70%, or 70% to 80%, or 85% to 90%, or 90% to 95%, or 95% to 96%, or 96% to 97%, or 97% to 98%, or 98% to 99% by weight of the composition. In some first embodiments, the solvent is the balance of the composition aside from the actives; that is, the composition consists of the solvent and the actives. In some first embodiments, the solvent is the balance of the composition aside from the scavenger, the amine, and the booster amine; that is, the composition consists essentially of or consists of a mixture of the scavenger, the amine, the booster amine, and the solvent.

In any one or more first embodiments herein, a composition includes one or more adjuvants. In some first embodiments herein, the composition comprises, consists essentially of, or consists of a mixture of the scavenger, the amine, the booster amine and the one or more adjuvants. In other such embodiments, the composition comprises, consists essentially of, or consists of a mixture of the scavenger, the amine, the booster amine, the solvent, and the one or more adjuvants. In any one or more first embodiments herein, the one or more adjuvants are selected from one or more surfactants, one or more biocides, one or more corrosion inhibitors, one or more anti-scale agents, one or more anti-emulsifiers, one or more anti-foaming agents, one or more emulsifiers, one or more foamers, one or more paraffin inhibitors, one or more asphaltene inhibitors, one or more hydrate inhibitors, one or more pH adjustment agents, or a combination of two or more thereof. In any one or more first embodiments herein, the total amount of the one or more adjuvants in the composition is about 0.1 wt % to about 10 wt %, such as 0.1 wt % to 1 wt %, or 1 wt % to 2 wt %, or 2 wt % to 3 wt %, or 3 wt % to 4 wt %, or 4 wt % to 5 wt %, or 5 wt % to 6 wt %, or 6 wt % to 7 wt %, or 7 wt % to 8 wt %, or 8 wt % to 9 wt %, or 9 wt % to 10 wt %.

In embodiments, a suitable adjuvant included in one or more compositions of first embodiments comprises, consists essentially of, or consists of a corrosion inhibitor. Suitable corrosion inhibitors include quaternary ammonium compounds, imidazolines, and reaction products of amines with fatty acids.

In embodiments, a suitable adjuvant included in one or more compositions of first embodiments comprises, consists essentially of, or consists of a biocide that is an antimicrobial agent. Suitable antimicrobial agents include, but are not limited to, compounds with a microbiostatic, disinfectant, or sterilization effect on a liquid material when added thereto. Nonlimiting examples of antimicrobials include bactericides, fungicides, nematicides, and the like. Bactericides include active chlorine disinfectants, e.g. including hypochlorites, chlorine dioxide, and the like; phenols such as triclosan, phenol itself, thymol, and the like; cationic surfactants such as quaternary ammonium surfactants, chlorhexidine, and the like; ozone, permanganates, colloidal silver, silver nitrate, copper based compounds, iodine preparations, peroxides, and strong acids and strong alkalis. Fungicides include, but are not limited to, strobilurins such as azoxystrobin, trifloxystrobin and pyraclostrobin; triazoles and anilino-pyrimidines such as tebuconazole, cyproconazole, triadimefon, pyrimethanil; and additionally compounds such as triadimefon, benomyl, captan, chlorothalonil, copper sulfate, cyproconazole, dodine, flusilazole, flutolanil, fosetyl-al, gallex, mancozeb, metalaxyl, prochloraz, propiconazole, tebuconazole, thiophanate methyl, triadimenol, tridimefon, triphenyltin hydroxide, ziram, and the like.

### Second Embodiments

Disclosed in second embodiments herein are methods of removing H₂S from an H₂S rich stream. The methods comprise, consist essentially of, or consist of applying any one of the compositions of first embodiments to an H₂S rich stream to form a treated stream. The H₂S rich stream is a fluid stream having a measurable amount of H₂S and/or another sulfhydryl compound therein, where sulfhydryl compounds are characterized as compounds that include an —SH moiety. The treated streams have a reduced amount of H₂S and/or another sulfhydryl compound when compared to the stream prior to the treatment, and the methods herein do not result in formation of insoluble solid products of the reaction between the sulfhydryl compound(s) and the hemiacetal scavenger.

In some second embodiments, the H₂S rich stream is an industrial fluid stream, such as a gaseous or liquid industrial processing stream, or a gaseous or liquid industrial waste stream.

In some second embodiments, the H₂S rich stream is an H₂S rich liquid stream comprising an energy liquid, that is, an H₂S rich energy liquid stream. H₂S rich energy liquids include crude oils and produced waters.

In some second embodiments, the H₂S rich stream is an H₂S rich gas stream comprising an energy gas, that is, an H₂S rich energy gas stream. H₂S rich energy gases include produced gases and biogases. In such embodiments, the applying of second embodiments comprises, consists essentially of, or consists of bubbling the H₂S rich gas stream through a composition of first embodiments, referred to in connection with this method as “scavenger fluid”. In some methods of second embodiments, the scavenger fluid is a composition of first embodiments that includes a solvent; in other such methods of second embodiments, the scavenger fluid is a neat composition of first embodiments.

In some such second embodiments, the rate of the bubbling is selected by the operator to provide sufficient contact between the H₂S rich gas stream and the composition actives to form a treated gas stream, which is collected for further treatment or for use as an energy gas. A treated gas stream is suitably characterized as having a reduced amount of H₂S compared to the H₂S rich gas stream. In some such embodiments, a treated gas stream is suitably characterized as no H₂S or substantially no H₂S, further wherein “substantially no H₂S” means that no H₂S can be detected, or measured, in the treated gas stream. A “reduced amount” of H₂S means measurably reduced compared to the amount of H₂S measured in the H₂S rich gas stream. In embodiments, the reduced amount of H₂S is the same or less as a set operator limitation, which may be between 4 ppm to 10 ppm H₂S for example, in accordance with private standards and/or regulatory limits; or for some gas streams may be even lower than 4 ppm, such as 3 ppm, or 2 ppm, or 1 ppm, or 500 ppb, or 100 ppb, or 50 ppb, or even 10 ppb.

In embodiments, a treated gas stream collected during the bubbling includes reduced H₂S, no H₂S, or substantially no H₂S until a sufficient volume of the H₂S rich gas stream has passed through the scavenger fluid that the actives are completely consumed by reaction with H₂S and/or other sulfhydryl compounds, and/or at a point in which the reaction kinetics are observed to slow to a point in which breakthrough occurs. Breakthrough is the point at which the levels of H₂S are too high to be collected because of set operator limitations.

When a scavenger fluid of first embodiments herein is contacted with an H₂S rich gas stream, one or more sulfhydryl compounds present in the gas stream, including H₂S, can react with the actives of the scavenger fluid to neutralize the sulfhydryl compounds by forming one or more reaction products thereof. Formation of the reaction products consumes the actives. Accordingly, a spent composition of second embodiments herein includes one or more products of one or more reactions between one or more sulfhydryl compounds and one or more actives present in the scavenger fluid. In some such embodiments the one or more sulfhydryl compounds comprises, consists essentially of, or consists of H₂S. At the point of breakthrough, a spent composition herein includes a reduced amount of actives, or even substantially no actives compared to the scavenger fluid prior to the bubbling.

Further in accordance with previously known systems based on bubbling H₂S rich gas streams through liquids containing hemiacetals and/or amines such as monoethanolamine triazine, it is well known by those of skill in the art that the reaction products of H₂S with the hemiacetal and/or triazine can result in solids formation, wherein the solids are insoluble in the liquid where they form, and consequently precipitate. The precipitate can quickly build up within the containment and/or other equipment holding or contacting the liquid, rendering the bubbling processes of previously known systems inoperable after a short period of time.

In sharp contrast, when an H₂S rich gas stream is bubbled through a scavenger fluid of first embodiments herein, further in accordance with the methods of second embodiments herein, a treated gas stream is collected, while precipitation of the reaction products is reduced, or prevented, or substantially prevented, even at the point of breakthrough. In some such embodiments, no precipitate is observed in the spent compositions for at least 1 hour, and as much as 200 hours or more after breakthrough, for example 1-6 hours, 6-12 hours, 12-24 hours, 24-36 hours, 36-48 hours, 48-60 hours, 60-72 hours, 72-84 hours, 84-96 hours, 96-108 hours, 108-120 hours, 120-132 hours, 132-144 hours, 144-156 hours, 156-168 hours, 168-180 hours, or 180-200 hours, or even more than 200 hours.

Accordingly, in any one or more second embodiments herein, a spent composition includes one or more reaction products of the reaction between one or more sulfhydryl compounds and one or more actives of the scavenger fluid, further wherein the spent composition excludes or substantially excludes a precipitate. In embodiments, a spent composition obtained by bubbling an H₂S rich gas stream through a scavenger fluid to the point of breakthrough, remains free or substantially free of precipitate. That is, in embodiments, a spent composition formed by the methods of second embodiments herein includes no precipitate observable to the naked human eye, or is transparent, or is substantially transparent. In other embodiments, a spent composition formed by the methods of second embodiments herein includes an observable precipitate, but the precipitate remains suspended therein and does not settle out of the spent composition or cause fouling of any surfaces.

Further in any one or more second embodiments herein, after breakthrough, a spent composition is a flowable fluid. By “flowable fluid” it is meant that a spent composition herein is characterized by one or more of the following: it is a liquid that can be pumped or poured using conventional liquid processing equipment; it is free or substantially free of gels and precipitates; it is clear or translucent; it is free of observable settling; it is free of observable fouling (of the interior surfaces of the containment containing the spent composition). In some second embodiments herein, a spent composition is a flowable fluid for at least about 1 hour and up to about 200 hours after breakthrough, for example 1-6 hours, 6-12 hours, 12-24 hours, 24-36 hours, 36-48 hours, 48-60 hours, 60-72 hours, 72-84 hours, 84-96 hours, 96-108 hours, 108-120 hours, 120-132 hours, 132-144 hours, 144-156 hours, 156-168 hours, 168-180 hours, or 180-200 hours after breakthrough. In other second embodiments herein, a spent composition is a flowable fluid for longer than 200 hours, such as for 500 hours, or 1,000 hours, or 5,000 hours, or 10,000 hours, or even longer.

The foregoing characterization of a spent composition is different from the results obtained in a spent hemiacetal-amine combination of the prior art. Previously, it was observed that in the reaction between H₂S and hemiacetals, certain amines-most notably tertiary amines such as triethanolamine or MEA triazine-could be combined with the hemiacetal to obtain greater rates of reaction. However, these favorable reaction kinetics were accompanied by formation insoluble solids either during the bubbling or within several hours afterwards, such as within 1 hour or less, or within 1-24 hours after breakthrough,

In sharp contrast, we have found that certain acyclic and cyclic amines provide an excellent rate of reaction when combined with a hemiacetal scavenger and used for bubbling one or more H2S rich gases therethrough. Addition of a booster amine, in particular a cyclic secondary amine, present in a minor amount proportionally to the amine and the scavenger, can improve the performance of the resulting mixture even further by increasing the apparent rate of reaction of the scavenger with the sulfhydryl compound(s). Accordingly, the compositions of first embodiments herein are suitable for obtaining excellent results when used in methods of second embodiments herein.

In any one or more second embodiments herein, methods of removing H₂S from an H₂S rich stream include methods of removing H₂S from an H₂S rich liquid stream comprising an energy liquid. H₂S rich energy liquids include crude oils and produced waters. Accordingly, in any one or more second embodiments herein, the H₂S rich liquid stream is a crude oil stream or a produced water stream. In such embodiments, the applying of second embodiments herein comprises, consists essentially of, or consists of adding about 1 ppm to about 10,000 ppm actives of a composition of first embodiments herein to an H₂S rich liquid stream to form a treated liquid stream. In embodiments, the treated liquid stream is a treated crude oil stream or a treated produced water stream.

In some embodiments, the treating comprises, consists essentially of, or consists of adding about 0.1 ppm to about 10,000 ppm by weight or w/v (where specified) actives of a composition of first embodiments herein to an H₂S rich liquid stream to form a treated liquid stream, for example adding 1 ppm to 10,000 ppm, or 10 ppm to 10,000 ppm, or 50 ppm to 10,000 ppm, or 100 ppm to 10,000 ppm, or 200 ppm to 10,000 ppm, or 300 ppm to 10,000 ppm, or 400 ppm to 10,000 ppm, or 500 ppm to 10,000 ppm, or 600 ppm to 10,000 ppm, or 700 ppm to 10,000 ppm, or 800 ppm to 10,000 ppm, or 900 ppm to 10,000 ppm, or 1000 ppm to 10,000 ppm, or 1500 ppm to 10,000 ppm, or 2000 ppm to 10,000 ppm, or 3000 ppm to 10,000 ppm, or 4000 ppm to 10,000 ppm, or 5000 ppm to 10,000 ppm, or 6000 ppm to 10,000 ppm, or 7000 ppm to 10,000 ppm, or 8000 ppm to 10,000 ppm, or 9000 ppm to 10,000 ppm, or 1 ppm to 5000 ppm, or 10 ppm to 5000 ppm, or 50 ppm to 5000 ppm, or 100 ppm to 5000 ppm, or 200 ppm to 5000 ppm, or 300 ppm to 5000 ppm, or 400 ppm to 5000 ppm, or 500 ppm to 5000 ppm, or 600 ppm to 5000 ppm, or 700 ppm to 5000 ppm, or 800 ppm to 5000 ppm, or 900 ppm to 5000 ppm, or 1000 ppm to 5000 ppm, or 1500 ppm to 5000 ppm, or 2000 ppm to 5000 ppm, or 3000 ppm to 5000 ppm, or 4000 ppm to 5000 ppm, or 0.01 to 0.1 ppm, or 0.1 ppm to 1 ppm, or 1 ppm to 10 ppm, or 10 ppm to 50 ppm, or 50 ppm to 100 ppm, or 100 ppm to 200 ppm, or 200 ppm to 300 ppm, or 300 ppm to 400 ppm, or 400 ppm to 500 ppm, or 500 ppm to 600 ppm, or 700 ppm to 800 ppm, or 800 ppm to 900 ppm, or 900 ppm to 1000 ppm, or 0.1 ppm to 1000 ppm, or 1 ppm to 1000 ppm, or 10 ppm to 1000 ppm, or 100 ppm to 1000 ppm, or 0.1 ppm to 500 ppm, or 1 ppm to 500 ppm, or 10 ppm to 500 ppm, or 100 ppm to 500 ppm, or 500 ppm to 700 ppm, or 700 ppm to 1000 ppm, or 1000 ppm to 1500 ppm, or 1500 ppm to 2000 ppm, or 2000 ppm to 2500 ppm, or 2500 ppm to 3000 ppm, or 3000 ppm to 3500 ppm, or 3500 ppm to 4000 ppm, or 4000 ppm to 4500 ppm, or 4500 ppm to 5000 ppm, or 5000 ppm to 5500 ppm, or 5500 ppm to 6000 ppm, or 6000 ppm to 6500 ppm, or 6500 ppm to 7000 ppm, or 7000 ppm to 7500 ppm, or 7500 ppm to 8000 ppm, or 8000 ppm to 8500 ppm, or 8500 ppm to 9000 ppm, or 9000 ppm to 9500 ppm, or 9500 ppm to 10,000 ppm by weight or w/v (where specified) of actives comprising, consisting essentially of, or consisting of a scavenger, an amine, and a booster amine to an H₂S rich treated crude oil stream or H₂S rich produced water stream, based on the volume or the weight of the H₂S rich treated crude oil stream or H₂S rich produced water stream. In some such embodiments, the composition of first embodiments is added neat. In other embodiments, the composition is added as a 0.1% to 99% solution by weight or w/v of actives in a solvent.

Accordingly, the methods of second embodiments herein further comprise methods of inhibiting corrosion of a surface, the methods comprising, consisting essentially of, or consisting of contacting a surface with a treated liquid stream, wherein corrosion of the surface is inhibited during the contact relative to the corrosion obtained by contacting the surface with the corresponding (untreated) H₂S rich liquid stream. Since H₂S and other sulfhydryl compounds are known to be corrodents, the reaction obtained between the H₂S/sulfhydryl compounds in the H₂S rich liquid stream effectively inhibits corrosion of the surfaces contacted by the liquid stream.

In embodiments the surface comprises, consists essentially of, or consists of a metal, a glass, a plastic, or any combination thereof. In embodiments the surface is a metal surface comprising, consisting essentially of, or consisting of metal. In embodiments, the metal surface is a carbon steel surface, a steel alloy surface, a stainless-steel surface, a copper alloy surface, a yellow metal surface, or a combination of two or more thereof. In embodiments, the metal surface comprises, consists essentially of, or consists of a carbon steel surface. In embodiments, the surface is an interior surface of a conduit, such as a pipe or a tube; a separator; or a containment such as a tank or a vat. In embodiments, the surface is located on a wellbore production string, on a water treatment facility, on a boiler, on a geothermal heat pump system, on a nuclear processing facility, on a water-cooling tower, or a combination of two or more thereof.

In embodiments, a treated liquid stream as described in second embodiments herein includes a reduced amount of one or more sulfhydryl compounds, when compared to the amount of the one or more sulfhydryl compounds present in the H₂S rich energy liquid. In embodiments, a treated liquid stream includes a reduced amount of H₂S when compared to the amount of H₂S present in the H₂S rich energy liquid. In embodiments, the treated liquid stream excludes or substantially excludes H₂S. In embodiments, a treated liquid stream excludes or substantially excludes a precipitate. In other embodiments, the treated liquid stream forms a precipitate, or includes a precipitate, but the precipitate does not cause fouling, that is, the precipitate remains suspended in the treated liquid stream and does not become statically associated with the interface between the treated liquid stream and a solid surface, such as a wall of a containment or conduit used to transport the treated liquid stream. Accordingly, if a precipitate does form in a treated liquid stream, it does not form a layer on any separator, conduit or containment contacting the treated liquid stream. Stated differently, if a precipitate does form in a treated liquid stream, the precipitate, the precipitate is not a foulant.

### Third Embodiments

Disclosed in third embodiments herein is the use of any one or more compositions of first embodiments to remove H₂S from an H₂S rich stream and form a treated stream. The H₂S rich stream is a fluid stream having a measurable amount of H₂S and/or another sulfhydryl compound therein. The treated streams have a reduced amount of H₂S and/or another sulfhydryl compound when compared to the stream prior to the treatment, and are characterized by the absence of insoluble solid products that cause fouling of surfaces contacted by the treated stream.

In some third embodiments, the H₂S rich stream is an industrial fluid stream, such as a gaseous or liquid industrial processing stream, or a gaseous or liquid industrial waste stream. In some third embodiments, the H₂S rich stream is an H₂S rich liquid stream comprising, consisting essentially of, or consisting of a crude oil and/or a produced water. In some third embodiments, the H₂S rich stream is an H₂S rich gas stream comprising an energy gas, that is, a produced gas or a biogas.

In some embodiments, the use is bubbling an H₂S rich gas stream through a composition of first embodiments herein; in other embodiments, the use is adding a selected amount of actives of a composition of first embodiments to an H₂S rich liquid stream.

### Fourth Embodiments

Disclosed in fourth embodiments herein are kits for carrying out the methods of second embodiments herein and for the uses of third embodiments herein. The kits of fourth embodiments herein comprise, consist essentially of, or consist of a container, the container having an interior volume containing any one of the compositions of first embodiments therein.

In some fourth embodiments, the composition consists essentially of or consists of the actives and one or more adjuvants. In other fourth embodiments, the composition consists essentially of or consists of the actives and one or more adjuvants. In still other fourth embodiments, the composition comprises the actives along with one or more adjuvants and/or a solvent.

### Fifth Embodiments

Disclosed in fifth embodiments herein are glyoxal treatment compositions comprising, consisting essentially of, or consisting of a mixture of a hemiacetal, a tertiary amine, and glyoxal. The hemiacetal of the glyoxal treatment compositions of fifth embodiments is any of the hemiacetals of the compositions of first embodiments herein. In embodiments, the weight ratio of glyoxal to the hemiacetal in the glyoxal treatment compositions is between 1:2 and 1:10.

In any one or more fifth embodiments, the mixture includes about 20 parts to about 80 parts by weight of a hemiacetal, about 1 part to 20 parts by weight of the tertiary amine, and about 10 to 40 parts by weight of glyoxal.

In any one or more fifth embodiments, the tertiary amine of the glyoxal treatment compositions of fifth embodiments comprises, consists essentially of, or consists of a heterocyclic compound, such as 1,4-diazabicyclo[2.2.2]octane (DABCO). In any one or more fifth embodiments, the tertiary amine is an aromatic amine, such as pyridine. In any one or more fifth embodiments, the tertiary amine comprises, consists essentially of, or consists of a trialkyl amine or a trialkanolamine. In any one or more fifth embodiments the tertiary amine has between 6 and 10 total carbon atoms. In any one or more fifth embodiments the tertiary amine comprises, consists essentially of, or consists of triethylamine, triethanolamine, hexahydro-1,3,5-tris(hydroxyethyl)-s-triazine (“MEA triazine”), N,N,N′,N′-tetramethylethylenediamine, pyridine, pyrimidine, acridine, phenazine, a benzoxazine, 3H-indole, 2H-azepine, azocine, azecine, DABCO, 1-azaadamantane, quinuclidine, any chemical derivative of these, or any combination or mixture thereof.

In any one or more fifth embodiments, a glyoxal treatment composition further includes a solvent, wherein the solvent is any of the solvents of the compositions of first embodiments herein. In some such embodiments, the glyoxal treatment composition includes between 20% and 80% of the solvent by weight or weight/volume (w/v).

### Sixth Embodiments

Disclosed in sixth embodiments herein are methods of removing H₂S from an H₂S rich stream by applying any one of the glyoxal treatment compositions of fifth embodiments to an H₂S rich stream to form a treated stream. The methods of applying of sixth embodiments are the same as the methods of second embodiments herein. Accordingly, in some sixth embodiments an H₂S rich gas stream is bubbled through a glyoxal treatment composition of fifth embodiments. In other embodiments a glyoxal treatment composition is added to an H₂S rich liquid stream.

### Seventh Embodiments

Disclosed in seventh embodiments herein is the use of any one or more compositions of fifth embodiments to remove H₂S from an H₂S rich stream and form a treated stream.

### Eighth Embodiments

Disclosed in eighth embodiments herein are kits for carrying out the methods of sixth embodiments herein, and for the uses of seventh embodiments herein. The kits of eighth embodiments herein comprise, consist essentially of, or consist of a container, the container having an interior volume containing any one of the compositions of fifth embodiments therein.

### EXPERIMENTAL SECTION

Formulations corresponding to Example 1-5 were formed by admixing the components shown in Table 1. The formulations of Examples 1-5 were tested by adding 100 g of each formulation to a glass tower equipped with gas inlet and outlet, pressure gauge, and excess pressure relief valve; and flowing 200 scc/min of a gas mixture of including H₂S and N₂ into the inlet to obtain 15 psig of pressure inside the tube, while monitoring the flow of gas exiting the tube through the outlet (“exit gas”) for H₂S using the procedure of ASTM D4084. For each formulation, the amount of time between the start of the test and when 500 ppm H₂S was detected in the exit gas was also recorded; time to 500 ppm H₂S is also listed in Table 1.

Once breakthrough was determined, the flow of gas into the tube was stopped, and the contents of the tube were emptied into a 100 mL glass jar and observed for transparency/clarity and signs of precipitation. Then the jar was capped and left to stand in ambient laboratory conditions. The jar was observed once each 24 hours thereafter, and the observations recorded, for the remainder of the test. Observations for Examples 1-5 are listed in Table 1.

TABLE 1
Components of the Control composition (no amine) and the
compositions of Examples 1-5; time to 500 ppm H₂S; time
to first observed solids in the formulations after concluding
H₂S bubbling; and rating of the solids observed:
0 = clear, no solids observed; 1 = cloudiness or
slight precipitation or gelation observed; 2 = significant
solids or gels observed on bottom of jars and/or adhered
to side walls; 3 = precipitation or solidification
observed to encompass the entire contents of the jar.
All components are recited in parts by weight.

| Component | Control | Ex. 1 | Ex 2 | Ex 3 | Ex. 4 | Ex. 5 |
|---|---|---|---|---|---|---|
| (ethylenedioxy) | 20 | 20 | 20 | 20 | 25 | 23 |
| dimethanol, EDDM | | | | | | |
| di-n-butylamine | 0 | 0 | 5 | 10 | 10 | 11.5 |
| diethylamine | 0 | 5 | 0 | 0 | 0 | 0 |
| n-butanol | 20 | 20 | 20 | 20 | 20 | 20 |
| water | 15 | 0 | 20 | 15 | 10 | 10.5 |
| methanol | 45 | 35 | 35 | 35 | 35 | 35 |
| Time to 500 ppm H₂S, | 0.13 | 4.78 | 3.17 | 3.72 | 5.83 | 4.88 |
| hours | | | | | | |
| Time from 500 ppm H₂S | N/A | 0 | 6 | >30 | 1-3 | 2-15 |
| to observed solids, days | | | | | | |
| Observed solids rating | N/A | 3 | 1 | 0 | 3 | 2 |

It can be seen in Table 1 that Examples 1-5 all obtained at least 3 hours until breakthrough, compared to the Control which obtained only about 8 minutes until breakthrough. In particular, Example 3 obtained 3.72 hours to breakthrough of H₂S, while also providing a clear spent composition (scavenging byproduct) for more than 30 days after breakthrough.

### Examples 6-7

The components shown in Table 2 were admixed, and the procedures of Examples 1-5 above were repeated for the admixtures of Examples 6-7. The results and observations related to Examples 6-7 are listed in Table 2.

TABLE 2
Components of the compositions of Examples 6-7; time to 500 ppm
H₂S; time to first observed solids in the formulations after concluding
H₂S bubbling; and rating of the solids observed.

| Component | Ex. 6 | Ex. 7 |
|---|---|---|
| EDDM | 20 | 20 |
| pyrrolidine | 2.5 | 0.5 |
| di-n-butylamine | 7.5 | 10 |
| n-butanol | 20 | 20 |
| water | 0 | 14.5 |
| methanol | 35 | 35 |
| Time to 500 ppm H₂S, hours | 4.8 | 4.45 |
| Time from 500 ppm H₂S to observed solids, days | 2-4 | 4 |
| Observed solids | 1 | 1 |

The formulations of Example 6 and Example 7 were found to rapidly remove all H₂S from the inlet gas stream. While not clear/transparent, the resulting spent compositions (post-500 ppm H₂S) are flowable liquids that are free of large solid aggregations; and the jar side walls were observed to be free of adhered precipitated deposits, which can restrict or plug flowlines or oilfield production processing equipment. Accordingly, Examples 6 and 7 achieve rapid scavenging of H₂S, while also providing flowable spent compositions (scavenging byproduct).

What is claimed is:

1. A composition comprising:
a. a scavenger,
b. an amine, and
c. optionally a booster amine.

2. The composition of claim 1 wherein the scavenger comprises a hemiformal, wherein the hemiformal scavenger is a reaction product of an alkanol or a polyol with formaldehyde or formalin.

3. The composition of claim 2 wherein the alkanol is a C1-C8 alkanol or a combination of two or more C1-C8 alkanols.

4. The composition of claim 2 wherein the polyol is ethylene glycol, diethylene glycol, triethylene glycol, 1,2-propylene glycol, 1,3-propylene glycol, glycerol, trimethylolpropane, erythritol, pentaerythritol, a C5-C6 sugar, a C5-C6 sugar alcohol, or any combination thereof.

5. The composition of claim 1 wherein the scavenger comprises (ethylenedioxy)dimethanol, methoxymethanol, ethoxymethanol, glycerol formal, or any combination thereof.

6. The composition of claim 1 wherein the scavenger comprises a hemiacetal that is a reaction product of alkanol or a polyol with an aldehyde selected from acetaldehyde, benzaldehyde, glutaraldehyde, glyoxal, or any combination thereof.

7. The composition of claim 6 wherein the alkanol is a C1-C8 alkanol or a combination of two or more C1-C8 alkanols; or wherein the polyol is ethylene glycol, diethylene glycol, triethylene glycol, 1,2-propylene glycol, 1,3-propylene glycol, glycerol, trimethylolpropane, erythritol, pentaerythritol, a C5-C6 sugar, a C5-C6 sugar alcohol, or any combination thereof.

8. The composition of claim 1 wherein the amine comprises an acyclic dialkylamine or dialkanolamine.

9. The composition of claim 1 wherein the amine comprises a cyclic amine having at least one secondary amine moiety.

10. The composition of claim 1 wherein the amine is selected from dimethylamine, diethylamine, di-n-propylamine, di-iso-propylamine, di-n-butylamine, di-iso-butylamine, di-t-butylamine, di-n-pentylamine, di-is-pentylamine, di-neo-pentane, di-n-hexylamine, di-(2-methylpentyl)amine, di-(3-methylpentyl)amine, di-(2,2-dimethylbutyl)amine, or di-(2,3-dimethylbutyl)amine, diethanolamine, aziridine or a derivative thereof, azetidine or a derivative thereof, pyrrolidine or a derivative thereof, piperidine or a derivative thereof, morpholine or a derivative thereof, azepane or a derivative thereof, indole or a derivative thereof, piperazine or a derivative thereof, azocane or a derivative thereof, diaminocyclohexane or a derivative thereof, homopiperazine or a derivative thereof, imidazoline or a derivative thereof, pyrrolidine-2,5-diamine or a derivative thereof, or any combination thereof.

11. The composition of claim 1 wherein the booster amine is a cyclic aliphatic secondary amine.

12. The composition of claim 1 wherein the booster amine is aziridine or a derivative thereof, azetidine or a derivative thereof, pyrrolidine or a derivative thereof, piperidine or a derivative thereof, morpholine or a derivative thereof, azepane or a derivative thereof, indole or a derivative thereof, piperazine or a derivative thereof, azocane or a derivative thereof, diaminocyclohexane or a derivative thereof, homopiperazine or a derivative thereof, imidazoline or a derivative thereof, pyrrolidine-2,5-diamine, or any combination thereof.

13. The composition of claim 1 wherein the proportion of the amine to the booster amine in the composition is about 100:1 to about 2:1 by weight; and/or wherein the weight proportion of the of scavenger to the total weight of the amine and the booster amine in the composition is about 100:1 to about 1:1.

14. The composition of claim 1, further comprising a solvent comprising water, one or more alkanols, one or more alkoxyalkanols, one or more aliphatic hydrocarbons, one or more aromatic hydrocarbons, or any mixture thereof.

15. The composition of claim 1, further comprising an adjuvant selected from corrosion inhibitors, surfactants, biocides, anti-scale agents, anti-emulsifiers, anti-foaming agents, emulsifiers, foamers, paraffin inhibitors, asphaltene inhibitors, hydrate inhibitors, pH adjustment agents, or any combination of two or more thereof.

16. A method of removing H₂S from an H₂S rich fluid stream, the method comprising applying a composition of claim 1 to an H₂S rich fluid stream to form a treated stream.

17. The method of claim 16 wherein the H₂S rich fluid stream is an H₂S rich energy fluid stream selected from a produced gas stream or a biogas stream, further wherein the applying is bubbling the energy fluid stream through the composition.

18. The method of claim 17 wherein the composition is neat, and wherein the applying causes the formation of one or more reaction products of H₂S with one or more components of the composition, further wherein the one or more reaction products do not precipitate.

19. The method of claim 16 wherein the H₂S rich fluid stream is a crude oil stream or a produced water stream, and wherein the applying is adding 0.1 ppm to 10,000 ppm by weight of the composition to the energy fluid stream.

20. The method of claim 19 further comprising contacting the treated stream with a surface, wherein the surface comprises metal, glass, plastic, or a combination of two or more thereof.

21. A composition comprising:
a. a hemiacetal,
b. a tertiary amine,
c. glyoxal, and
d. optionally a solvent.

22. A method of removing H₂S from an H₂S rich stream, the method comprising applying the composition of claim 21 to an H₂S rich stream to form a treated stream.
